(19) United States
(12) Patent Application Publication
(10) Pub. No.: US 2023/0316267 A1
(43) Pub. Date: Oct. 5, 2023

(54) VEHICLE DATA SHARING FOR COLLABORATIVE DRIVING EXPERIENCE

(71) Applicant: Dr. Ing. h.c. F. Porsche Aktiengesellschaft, Stuttgart (DE)

(72) Inventors: Ethan Papp, Fremont, CA (US); Thomas Lai, Irvine, CA (US); Cyril Dorsaz, San Francisco, CA (US)

(73) Assignee: Dr. Ing. h.c. F. Porsche Aktiengesellschaft, Stuttgart (DE)

(21) Appl. No.: 17/711,158

(22) Filed: Apr. 1, 2022

(51) Int. Cl. G06Q 20/36; H04W 4/021; H04W 4/40

(52) U.S. Cl. CPC G06Q 20/3678; H04W 4/021; H04W 4/40

(57) ABSTRACT

A computer-implemented method and computer program for executing vehicle data sharing between vehicles. The method includes the steps of transmitting location data to a first network identifying a location of a first vehicle on a roadway; receiving data from the first network indicating that a second vehicle is within a predetermined proximity of the first vehicle; and transmitting data from the first vehicle to the second vehicle via a second network. The first network may be a cellular network, and the second network may be a Wi-Fi network. Also described is a method for executing a cryptocurrency transaction between the vehicles including the steps of receiving, and then comparing, respective vehicle performance related data from the first and second vehicles; and debiting a wallet of one of the two vehicles and crediting the wallet of the other vehicle of the vehicles as a function of the comparison.

### TECHNICAL FIELD AND BACKGROUND OF THE INVENTION

The present subject matter relates to a system and method for enabling communications, data sharing and financial transactions between vehicles.

### SUMMARY OF INVENTION

According to one aspect of the invention, a computer-implemented method for executing vehicle data sharing between vehicles is provided, said method comprising: (a) transmitting location data to a first network identifying a location of a first vehicle on a roadway; (b) receiving data from the first network indicating that a second vehicle is within a predetermined proximity of the first vehicle; and (c) transmitting data from the first vehicle to the second vehicle via a second network.

According to another aspect of the invention, a computer-implemented method for executing vehicle data sharing between vehicles is provided, said method comprising: (a) receiving location data via a first network from multiple vehicles; and (b) wirelessly connecting over a second network at least two vehicles of the multiple vehicles, which are located not greater than a predetermined distance away from one another, to enable communications between the at least two vehicles over the second network.

According to yet another aspect of the invention, a computer-implemented method for executing a cryptocurrency transaction between connected vehicles is provided, said method comprising: (a) receiving location data identifying a location of a first vehicle on a roadway; (b) receiving location data identifying a location of a second vehicle on the roadway; (c) wirelessly connecting the first vehicle to the second vehicle to enable communications therebetween; (d) receiving data from the first and second vehicles indicating a contract formed between the first and second vehicles to engage in a performance related contest; (e) receiving respective vehicle performance related data from the first and second vehicles; (f) comparing the vehicle performance related data from the first and second vehicles; and (g) debiting a wallet of one of the two vehicles and crediting the wallet of the other vehicle of the vehicles as a function of the comparison at step (f).

### BRIEF DESCRIPTION OF THE DRAWINGS

The drawing figures depict one or more implementations, by way of example only, not by way of limitations. In the figures, like reference numerals refer to the same or similar elements.

FIG. 1 depicts a schematic diagram of a vehicle and a mobile device that is connected to the vehicle (either wired or wirelessly).

FIG. 2 is a flowchart depicting an exemplary method for executing vehicle data sharing between vehicles.

FIG. 3 is a flowchart depicting an exemplary method for executing a cryptocurrency transaction between connected vehicles.

### DETAILED DESCRIPTION OF THE INVENTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

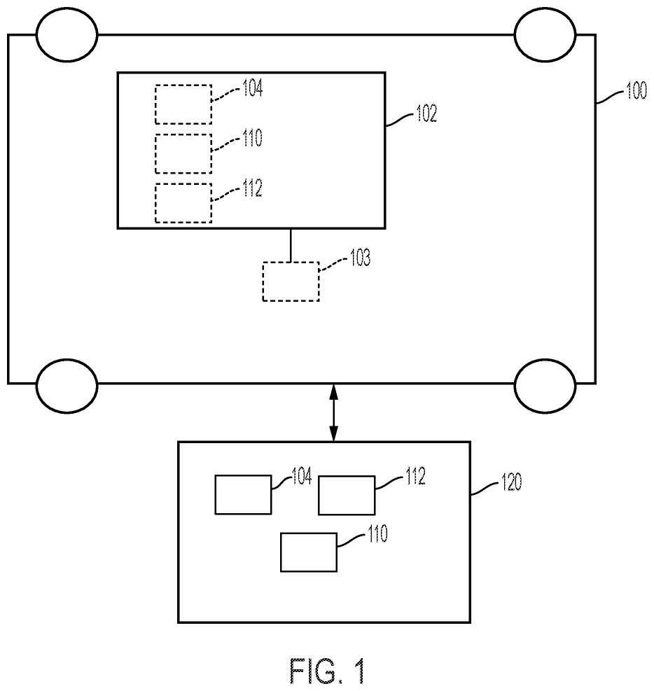

FIG. 1 depicts a vehicle 100 having a computer 102 for controlling operations of vehicle 100. Computer 102 includes a wireless receiver/transmitter for receiving data and transmitting data. Computer 102 receives various performance characteristics of vehicle 100 from sensors 103 throughout the car, the characteristics including vehicle position, speed, acceleration (e.g., via an acceleration sensor 103), lateral acceleration, steering angle, braking, engine RPM, power breaking (i.e., burnout) duration, and so forth.

Vehicle computer 102 includes a processor, an internal clock, a memory, a visual display having means for both inputting data and displaying data (e.g., touchscreen), and a transmitter/receiver for communicating with a mobile device 120, a cloud server, and/or other vehicles 100 in a conventional manner. Vehicle computer 102 may send and receive data via Wi-Fi or 5G/4G/LTE radios built into vehicle 100, by way of example.

An electronic mobile device 120 (otherwise referred to herein as a smartphone) is connected to vehicle computer 102 via a wired or wireless connection (e.g., Wi-Fi, cellular or Bluetooth connection). Computer 102 is configured to share the aforementioned performance characteristics of vehicle 100 with mobile device 120. Mobile device 120 includes a processor, a clock, a memory, a visual display having means for both inputting data and displaying data (e.g., touchscreen), and a transmitter/receiver for communicating with vehicle 100, the cloud server, and/or other vehicles 100 in a conventional manner.

It is noted that mobile device 120 is optional, and may be omitted in favor of using computer 102 of vehicle to carry out various steps of the method(s) described herein. Alternatively, computer 102 may be omitted in favor of using (only) mobile device 120 to carry out various steps of the method(s) described herein. It is noted that a cloud server can carry out the remaining steps of the method(s) described herein. If computer 102 is omitted, then it is noted that mobile device 120 can also be configured to measure the aforementioned performance characteristics of vehicle 100 either with or without communicating with vehicle 100.

A computer program 104 (program or application (‘App)) is stored in either computer 102 of vehicle 100 or electronic mobile device 120 (or both). According to one embodiment, program 104 is stored within the mobile device 120; information can be inputted into program 104 via the display of mobile device 120 and/or vehicle computer 102 (e.g., via CarPlay); and information can be outputted from program 104 via the display of mobile device 120 and/or vehicle computer 102. According to another embodiment, program 104 is stored within the vehicle computer 102; information can be inputted into program 104 via the display of vehicle computer 102; and information can be outputted from program 104 via the display of vehicle computer 102.

Program 104 is connected to receive and transmit information from/to a GPS device 110 (e.g., a GPS chip) that uses the Global Positioning System (GPS). GPS device 110 is configured to determine the location of vehicle 100 (or mobile device 120 within vehicle 100) in a conventional manner. GPS device 110 may form part of vehicle computer 102 or mobile device 120. This locational data can be stored in memory 112. Memory 112 may also form part of vehicle computer 102 or mobile device 120.

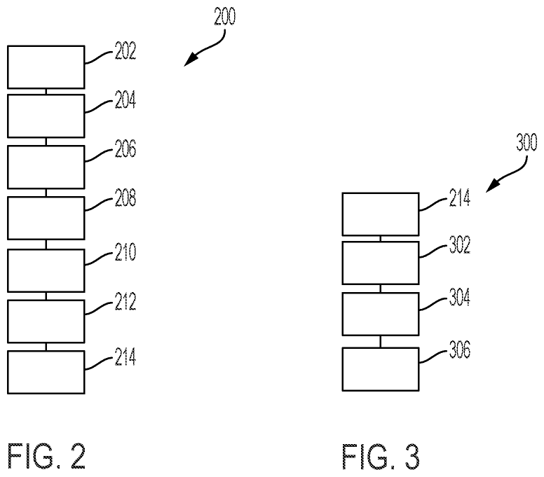

FIG. 2 depicts a flowchart depicting a method 200 for executing vehicle data sharing between vehicles. At the outset it is noted that method 200 uses mobile device 120 along with vehicle 100 to accomplish method 200, however, it should be understood that mobile device 120 may be omitted and various steps of method 200 may be completed using vehicle 100 alone.

At step 202 of method 200, program 104 (i.e., the ‘App’) of multiple mobile devices 120 transmit data over a first network (e.g., a cellular network) to a cloud server. The data relates to the location of each vehicle 100 and/or each device 120 (identified using GPS device 110).

The cloud server includes a processor that geofences multiple devices (e.g., multiple vehicles 100 and/or multiple mobile device 200) that are located within the confines of a geofence. The cloud server may be hosted by the purveyor of program 104.

According to www.verizonconnect.com, a geofence is a virtual fence or perimeter around a physical location. Like a real fence, a geofence creates a separation between that location and the area around it. Unlike a real fence, it can also detect movement inside the virtual boundary. The geofence can be any size or shape, even a straight line between two points. The size and shape may be pre-determined (e.g., an area measuring 5 kilometers by 5 kilometers). Further details in connection with a geofence are described in U.S. Pat. No. 10,993,072, which is incorporated by reference herein in its entirety.

At step 204, the cloud server identifies that multiple vehicles are positioned within a particular geofence (or are separated by less than a predetermined maximum distance), and transmits that locational information to the programs 104 of those multiple vehicles. The program 104 of mobile device 120, as well as the programs 104 of the other mobile device 120 of the multiple vehicles, which are located within the geofence, notify their respective users that other users of program 104 are in close proximity.

Program 104 may be programmed to (only) identify others users within the geofence meeting specific criteria, such as users having the same or similar vehicle make, vehicle model, performance rating, etc., users belonging to the same club (e.g., car club), users sharing similar interests (e.g., racers, enthusiasts, etc.), users of the same or opposite sex (or singles generally), users having cryptocurrency accessible by program 104, or users in a similar age group, for example.

At step 206, using program 104, two (or more) users agree to receive/transmit vehicle data to the other users within the geofence.

At step 208, the program 104 triggers the connected user devices 120 to disconnect from the first network and connect to a second network, e.g., a local device-to-device communication protocol, such as the protocol developed by APPLE™, which is commonly referred to as ‘multipeer networking.’

According to https://developer.apple.com/, the Multipeer Connectivity framework supports the discovery of services provided by nearby devices and supports communicating with those services through message-based data, streaming data, and resources (such as files). In iOS, the framework uses infrastructure Wi-Fi networks, peer-to-peer Wi-Fi, and Bluetooth personal area networks for the underlying transport. Multipeer networking enables communications between devices at low latency and without the need for a cellular data connection to a backend. Further details in connection with multipeer networking are described in U.S. Pat. No. 9,473,574, which is incorporated by reference herein in its entirety.

Simply stated, at step 208, program 104 seamlessly and transparently arbitrates between a remote data connection over a first network and a local device-to-device connection over a second network.

Alternatively, the data could continue to be transmitted via the first cellular network in lieu of multipeer networking (i.e., bypassing step 208).

At step 210, after the connected user devices 120 are paired locally (e.g., via step 208), data sharing between the devices 120 commences. The data comprises informational items related to a vehicle and may include the following: vehicle identifier (e.g., name of vehicle owner, make/model/year/color of vehicle, nickname/username for vehicle or vehicle owner, photo of vehicle, photo of user, etc.), vehicle destination, vehicle position (identified using GPS device 110), text messages, voice messages, current music/audio selection, music library, photo library, cryptocurrency transaction data, and/or the above-described performance characteristics of vehicle 100. Using program 104, the owner/user/operator of vehicle 100 can closely control the types of information that is shared with others. Also, with respect to the performance characteristics, those characteristics can be measured by sensors 103 in a vehicle or sensors in a mobile device 120.

At step 212, for each user, the received data shared by the other connected user devices 120 is displayed on the display of the user's device 120 and/or the display of the user's vehicle 100. Information that may be displayed includes the above-described ‘informational items.’

At step 214, using program 104, the connected users communicate with each other via the local multipeer network and, e.g., via CarPlay in the respective vehicles 100. Communications can include messages containing competition challenges (e.g., which vehicle can travel from 0-60 mph in the shortest amount of time). The competition challenges can be pre-loaded into program 104 and selected by the users.

FIG. 3 depicts a flowchart depicting an exemplary method 300 for executing a cryptocurrency transaction between connected vehicles 100 and/or devices 120. As noted above, at step 214, using program 104, the connected users challenge each other to performance competitions. Such competitions could encompass highest longitudinal acceleration, highest lateral acceleration, loudest exhaust, maximum speed, fastest 0-60 time, fastest 60-0 time, fastest time from one location to another location (using GPS), minimum braking distance, longest burnout duration, shortest charge time remaining, quickest charge, or any other challenge involving performance and/or operation of the vehicle. Alternatively, the competitions could focus on safe driving characteristics (e.g., drive speed closest to speed limits).

As part of step 214, the users set the competition type as well as a wager amount, thereby forming a smart contract between those ‘connected’ users. For example, one of the users can propose the competition type and wager amount, while the other connected users can either accept or decline the proposed competition type and/or wager amount.

At step 302, once a smart contract has been formed between multiple users and the competition has begun, the vehicle computers 102 (and/or devices 120) transmit to program 104 their respective performance related information (speed, acceleration, etc.) depending upon the type of competition. The connected groups performance related information is transmitted to each of the connected vehicles 100 and/or devices 120 via the multipeer network, and displayed by all of the connected vehicles 100 and/or devices 120.

At step 304, program 104 identifies the winner(s) and loser(s) of the challenge, and displays the winner(s) and loser(s) of the challenge via displays of all of the connected vehicles 100 and/or devices 120.

At step 306, program 104 rewards the winner of the challenge by automatically transferring virtual cryptocurrency from the loser(s) wallet to the winner(s) wallet via a secure transaction (encompassing cryptography or blockchain), as is well understood in the art. Program 104 may either contain a cryptocurrency wallet or have access to such a wallet. The wallet may be funded by a user's credit card, for example. The smart cryptocurrency contract between the users offers an automatic and unbiased settlement of the challenge.

As an alternative to a challenge, the users of the connected vehicles 100 and/or devices 120 may simply transfer cryptocurrency to others in the group for any reason, such as to reward the user having the nicest vehicle or the best driving skills, and so forth.

It should be understood that methods 200 and 300 are not limited to any particular step or sequence of steps.

It will be understood that the operational steps described above are performed by the computers or processors described herein upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the computers or processors described herein described herein is implemented in software code or instructions which are tangibly stored on a tangible computer readable medium. Upon loading and executing such software code or instructions by the computers or processors, the computers or processors may perform any of the functionality of the computers or processors described herein, including any steps of the methods described herein.

The term “software code” or “code” used herein refers to any instructions or set of instructions that influence the operation of computers or processors. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

It will also be understood that the terms and expressions used herein have the ordinary meaning as is accorded to such terms and expressions with respect to their corresponding respective areas of inquiry and study except where specific meanings have otherwise been set forth herein. The terms “comprises,” “comprising,” “includes,” “including,” or any other variation thereof, are intended to cover a non-exclusive inclusion, such that a process, method, article, or apparatus that has, comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A computer-implemented method for executing vehicle data sharing between vehicles, said method comprising:
(a) transmitting location data to a first network identifying a location of a first vehicle on a roadway;
(b) receiving data from the first network indicating that a second vehicle is within a predetermined proximity of the first vehicle; and
(c) transmitting data from the first vehicle to the second vehicle via a second network.

2. The computer-implemented method of claim 1, wherein the first network is a cellular network.

3. The computer-implemented method of claim 2, wherein the first and second vehicles are located within the confines of the same geofence.

4. The computer-implemented method of claim 1, wherein the second network is a Wi-Fi network.

5. The computer-implemented method of claim 1, wherein the first network is a cellular network, and the second network is a Wi-Fi network.

6. The computer-implemented method of claim 1, wherein between steps (b) and (c), the method further comprises the step of granting approval for the transmission of data from the first vehicle to the second vehicle.

7. The computer-implemented method of claim 1, wherein the data transmitted from the first vehicle to the second vehicle includes one or more of the following informational items relating to the first vehicle: vehicle model, vehicle make, name or username of a driver/owner/user of the first vehicle, contact information for the driver/owner/user, audio track playing in the first vehicle, speed of the first vehicle, performance characteristics of the first vehicle, and destination of the first vehicle.

8. The computer-implemented method of claim 7, wherein the vehicle-related data includes two or more of said informational items.

9. The computer-implemented method of claim 1 further comprising the step of receiving data at the first vehicle that was transmitted by the second vehicle via the second network.

10. A computer-implemented method for executing vehicle data sharing between vehicles, said method comprising:
(a) receiving location data via a first network from multiple vehicles; and
(b) wirelessly connecting over a second network at least two vehicles of the multiple vehicles, which two vehicles are located a distance away from one another that is not greater than a predetermined distance, to enable communications between the at least two vehicles over the second network.

11. The computer-implemented method of claim 10, wherein the first network is a cellular network, and the second network is a Wi-Fi network.

12. A computer-implemented method for executing a cryptocurrency transaction between connected vehicles, said method comprising:
(a) wirelessly connecting a first vehicle to a second vehicle to enable communications therebetween;
(b) receiving data from the first and second vehicles indicating a contract formed between the first and second vehicles to engage in a performance related contest;
(c) receiving vehicle performance related data from the first and second vehicles in connection with the performance related contest;
(d) comparing the vehicle performance related data from the first and second vehicles; and
(e) debiting a wallet of one of the two vehicles and crediting the wallet of the other vehicle of the vehicles as a function of the comparison at step (d).

13. The method of claim 12, wherein the first and second vehicles are located within the same geofence.

14. The method of claim 12, wherein prior to the wireless connection step, the method further comprising the steps of:
receiving location data identifying a location of a first vehicle on a roadway; and
receiving location data identifying a location of a second vehicle on the roadway.
